(19) United States
(12) Patent Application Publication
(10) Pub. No.: US 2024/0415729 A1
(43) Pub. Date: Dec. 19, 2024

(54) NECK MASSAGING SYSTEMS AND METHODS OF USING THE SAME

(71) Applicant: University of Washington, Seattle, WA (US)

(72) Inventors: Laligam Natarajan SEKHAR, Seattle, WA (US); Varadaraya Satyanarayan SHENOY, Seattle, WA (US); Michael A. WILLIAMS, Seattle, WA (US); Paranhothy KARUNAHARAN, Seattle, WA (US); Ramulu MAMIDALA, Seattle, WA (US); Garrett M. KELLEY, Seattle, WA (US); Aniruddh VASHISTH, Seattle, WA (US); Ravindra Onkar PATIL, Seattle, WA (US)

(21) Appl. No.: 18/698,565

(22) PCT Filed: Oct. 11, 2022
(86) PCT No.: PCT/US2022/046303

§ 371 Date: Apr. 4, 2024

Related U.S. Application Data
(60) Provisional application No. 63/256,451, filed on Oct. 15, 2021.

(51) Int. Cl. A61H 15/00; A61H 9/00

(52) U.S. Cl. CPC A61H 15/0078; A61H 9/0078; A61H 2015/0014; A61H 2201/0188; A61H 2201/1611; A61H 2201/1671; A61H 2205/04

(57) ABSTRACT

An example neck massaging system includes a housing. The housing is configured to fit around a neck of a wearer. As such, the housing includes an interior region defining an opening configured to receive the neck. The housing also includes a top region and a bottom region opposite the top region. The neck massaging system further includes at least one massager attached to the housing. The massager is positioned on the housing to be adjacent to the interior region which allows the massager to contact the neck. In an example, the massager is positioned on the housing such that the massager contacts the internal jugular vein. The neck massaging system also include at least one actuator operably coupled to the massager. The actuator is configured to move a portion of the massager adjacent to the neck in a direction that generally extends from the top region to the bottom region.

### CROSS-REFERENCE TO RELATED APPLICATION

This application claims priority to U.S. Provisional Patent Application 63/256,451 filed on Oct. 15, 2021, the disclosure of which is incorporated herein, in its entirety, by this reference.

### BACKGROUND

Intracranial pressure is the pressure exerted by fluids (e.g., blood and cerebrospinal fluid) inside the skull and on the brain tissue. The body has various mechanisms to keep the intracranial pressure at a safe level. However, the body may be unable to control the intracranial pressure in certain circumstances which may lead to adverse health outcomes. An example of a circumstance that may lead to unsafe intracranial pressure includes microgravity induced cerebral and jugular venous congestion as a possible mechanism which can lead to space-flight associated neuro-ocular syndrome (“SANS”).

During SANS, due to the loss of gravitational forces, venous flow to the heart from the brain is impaired and leads to chronic venous congestion of the brain which, in turn, leads to chronically increased intracranial pressure and eventually to papilledema and visual loss, Other examples of circumstances that may lead to high intracranial pressure includes concussions, head injuries, post-operative hydrocephalus, and pseudotumor cerebri, also known as idiopathic intracranial hypertension. The general method for alleviating intracranial pressure includes surgical implantation of a shunt and endovascular insertion of stents into the cerebral venous sinuses, both of which are associated with an increased risk of infection, long recoveries, long term health issues, or other adverse health outcomes.

### SUMMARY

Embodiments are directed to neck massaging systems and methods of using the same. In an embodiment, a neck massaging system is disclosed. The neck massaging system includes a housing defining an opening configured to receive a neck. The housing includes a top region, a bottom region opposing the top region, and an interior region defining at least a portion of the central opening. The neck massaging system also includes at least one massager attached to the housing adjacent to the interior region. The at least one massager is positioned on the housing to be positioned proximate to the internal jugular vein when the central opening receives the neck. The neck massaging system further includes at least one actuator operably coupled to the at least one massager. The at least one actuator is configured to move the at least one massager such that a portion of the at least one massager proximate the neck moves in a general direction extending from the top region towards the bottom region.

In an embodiment that may be used with any of the other embodiments disclosed herein, the housing includes an open end and the neck massaging system further comprises a front clasp attached to the housing. The front clasp is configured to selectively close or open the open end.

In an embodiment that may be used with any of the other embodiments disclosed herein, the at least one massager includes an inflatable bladder.

In an embodiment that may be used with any of the other embodiments disclosed herein, the at least one massager includes at least one roller configured to rotate in a general direction extending from the top region towards the bottom region.

In an embodiment that may be used with any of the other embodiments disclosed herein, the at least one roller exhibits a generally cylindrical shape.

In an embodiment that may be used with any of the other embodiments disclosed herein, the at least one roller includes a body and at least one protrusion extending from the body.

In an embodiment that may be used with any of the other embodiments disclosed herein, the at least one roller includes two or three rollers on a left side of the housing and two or three rollers on a right side of the housing.

In an embodiment that may be used with any of the other embodiments disclosed herein, the at least one actuator is configured to vary at least one of a pressure applied from the at least one massager to the internal jugular vein or a frequency at which the at least one massager moves.

In an embodiment that may be used with any of the other embodiments disclosed herein, the neck massaging system further comprises at least one moveable support. The at least one massager is attached to and supported by the at least one moveable support. The at least one moveable support is configured to rotate relative to a remainder of the housing.

In an embodiment that may be used with any of the other embodiments disclosed herein, the neck massaging system further comprises a membrane extending over the at least one massager.

In an embodiment that may be used with any of the other embodiments disclosed herein, the neck massaging system further comprises at least one vein/artery sensor. The at least one vein/artery sensor is configured to identify at least one of the internal jugular vein, the common carotid artery, the internal carotid artery, or the external carotid artery, or the external carotid artery.

In an embodiment that may be used with any of the other embodiments disclosed herein, the neck massaging system further comprises a light-emitting device communicably connected to the at least one vein/artery sensor. The light-emitting device is configured to illuminate at least one of the internal jugular vein or the external carotid artery responsive to the at least one vein/artery sensor identifying at least one of the internal jugular vein or the external carotid artery.

In an embodiment that may be used with any of the other embodiments disclosed herein, wherein the at least one vein/artery sensor includes at least one of an ultrasound sensor or an optical coherence tomography probe.

In an embodiment that may be used with any of the other embodiments disclosed herein, the neck massaging system further comprises electrical circuitry and at least one non-transitory memory coupled to the electrical circuitry, the at least one non-transitory memory storing one or more operational instructions and the electrical circuitry configured to execute the operational instructions.

In an embodiment that may be used with any of the other embodiments disclosed herein, the neck massaging system further comprises at least one additional massager spaced from the at least one massager.

In an embodiment, a method of using a massaging system is disclosed. The method includes positioning a housing of the neck massaging system around a neck of a wearer such that the neck is disposed in an opening defined by the housing. The housing includes a top region, a bottom region opposite the top region, and an interior region defining at least a portion of the central opening. The method also includes adjusting the housing such that at least one massager of the neck massaging system is positioned adjacent to the internal jugular vein of the individual. The at least one massager is attached to the housing. The method further includes moving a portion of the at least one massager closest to the neck in a general direction extending from the top region towards the bottom region using at least one actuator coupled to the at least one massager.

In an embodiment that may be used with any of the other embodiments disclosed herein, adjusting the housing such that at least one massager of the neck massaging system is positioned adjacent to the internal jugular vein of the individual includes adjusting the housing such that the at least one massager is positioned at or near a base of the neck and is spaced from an external carotid artery of the wearer.

In an embodiment that may be used with any of the other embodiments disclosed herein, the at least one massager includes at least one roller and moving at least a portion of the at least one massager includes rotating the at least one roller.

In an embodiment that may be used with any of the other embodiments disclosed herein, moving at least a portion of the at least one massager includes varying at least one of a pressure applied from the at least one massager to the internal jugular vein or a frequency at which the at least one massager moves.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of a neck massaging system, according to an embodiment.

FIG. 2A is an isometric view of neck massaging system, according to an embodiment.

FIG. 2B is a schematic cross-sectional view of the first massaging section to show components of the massaging system, according to an embodiment.

FIG. 3A is an isometric view of a neck massaging system, according to an embodiment.

FIG. 3B is a top plan view of the moveable support, according to an embodiment.

FIG. 4 is an isometric view of a neck massaging system, according to an embodiment.

FIGS. 5A and 5B are isometric views of a neck massaging system, according to an embodiment.

FIGS. 6A and 6B are isometric views of different massagers, according to different embodiments.

### DETAILED DESCRIPTION

Embodiments are directed to neck massaging systems and methods of using the same. An example neck massaging system includes a housing. The housing is configured to fit around a neck of a wearer. As such, the housing includes an interior region defining an opening configured to receive the neck. The housing also includes a top region and a bottom region opposite the top region. The neck massaging system further includes at least one massager (e.g., roller) attached to the housing. The massager is positioned on the housing to be adjacent to the interior region which allows the massager to contact the neck. In a particular example, the massager is positioned on the housing such that the massager contacts (through the skin and tissue of the neck and, in some embodiments, a membrane) the internal jugular vein (“IJV”). The neck massaging system also include at least one actuator operably coupled to the massager. The actuator is configured to move a portion of the massager adjacent to the neck in a direction that generally extends from the top region to the bottom region.

During use, the housing is positioned around the neck of the wearer. In other words, the neck is positioned in the central region. After positioning the housing around the neck, the position of the housing may be adjusted such that the massager is positioned adjacent to the IJV. After positioning the massager adjacent to the IJV, the actuator of the neck massaging system causes the massager to move so that the portion of the massager adjacent to the neck moves in a direction that generally extends from the top region to the bottom region. Such movement of the massager causes the portion of the massager adjacent to the IJV to move along the IJV in a direction that extends from the top of the neck to the bottom of the neck. Such movement of the massager along the IJV promotes forward blood flow in the IJV. In particular, such movement of the massager along the UV pulls blood from the brain and pushes the blood towards the heart. In other words, the neck massaging system may non-invasively increase blood flow in the IJV, modulate intracranial cerebrospinal fluid dynamics, and decrease elevated intracranial pressure. For example, use of the neck massaging system may reduce intracranial pressure by about 10% or more, about 20% or more, about 50% or more, or in ranges of about 10% to about 20% or about 20% to about 50%. The neck massaging system may be configured for use on a wearer in at least one of the standing, sitting, prone, or supine position.

Moving the blood from the brain and towards the heart through the IJV using the neck massaging system is an improvement over conventional methods for alleviating intracranial pressure. For example, conventional methods for alleviating intracranial pressure may employ neurosurgery and the use of invasive tools such as ventricular drains and shunts. Neurosurgery and these invasive tools are associated with 5-20% risk of infection. The invasive tools may malfunction thereby requiring repeat neurosurgery. As such, the neurosurgery and invasive tools conventionally used to alleviate intracranial pressure adversely affects the quality of life for patients and also leads to an overall increase in healthcare costs.

Embodiments of the neck massaging systems disclosed herein are effective to alleviate or at least decrease intracranial pressure. Decreasing the intracranial pressure with the neck massaging system may be sufficient to avoid neurosurgery which may lead to better health outcomes. The neck massaging system may also be used in situations where neurosurgery is not possible, such as by first responders providing emergency treatment during the pre-hospital period of care or during post-operation treatments. As such, the neck massaging system may lead to an improvement in the quality of care and clinical outcomes for patients, reduce the cost of care, decrease infections, and decrease the need for surgical interventions.

Embodiments of the neck massaging systems disclosed herein may also alleviate spaceflight associated neuro-ocular syndrome (“SANS”). SANS is a pathophysiological response experienced by astronauts during prolonged spaceflights. SANS results from an increase in baseline intracranial pressure and may cause structural alterations in the eyes as well as changes in visual acuity. The neck massaging system may improve venous outflow from the brain which may increase forward blood flow and consequently reduce the intracranial pressure caused by SANS.

Embodiments of the neck massaging systems disclosed herein may also be used to treat other neurological conditions other than those disclosed above. In an example, the neck massaging system may be used to treat concussions, traumatic brain injuries, and mild to moderate head injuries thereby quickening recovery, promoting early return to work, and improving long term cognitive outcomes. In an example, the neck massaging system may be used as a replacement for shunts used to treat neurological conditions. Examples of such neurological conditions includes hydrocephalus, infection, and chronically elevated intracranial pressure (e.g., caused by pseudotumor cerebri idiopathic intracranial hypertension). In an example, the neck massaging system may be used as pain relief from chronic headaches associated with elevated intracranial pressure (e.g., intracranial hypertension without papilledema). In an example, the cerebral venous outflow through the IJV caused by the neck massaging system may have therapeutic implications for conditions affecting cognitive abilities. Examples of such conditions may include Alzheimer's disease and dementia since the neck massaging system may augment glymphatic clearance of metabolic solutes in the brain parenchyma (i.e., increase intracranial glympatic circulation and turnover). In an example, the neck massaging system may improve cognition in sleep deprived soldiers. In an example, the neck massaging systems may be used to increase intracranial cerebrospinal fluid circulation and turnover by increasing cerebrospinal fluid reabsorption into the brain venous system and reduce intracranial pressure.

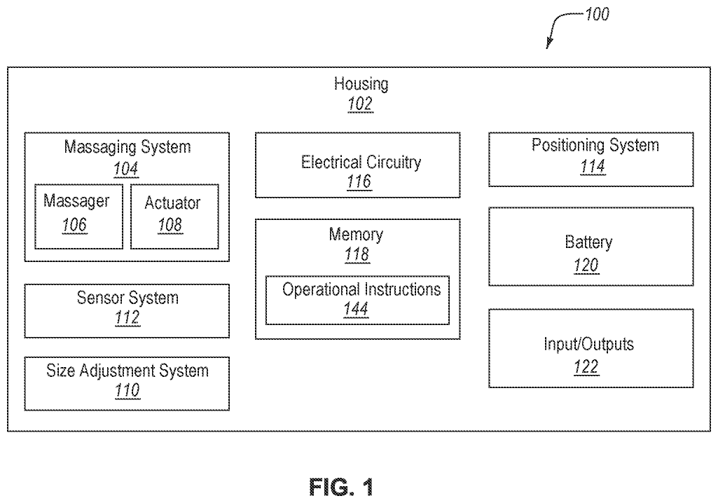

FIG. 1 is a block diagram of a neck massaging system 100, according to an embodiment. The neck massaging system 100 includes a housing 102. The neck massaging system 100 further includes a massaging system 104 at least partially disposed in or otherwise attached to the housing 102. The massaging system 104 includes at least one massager 106 and at least one actuator 108 configured to move the massager 106. As previously discussed, the massager 106 is configured to move relative to the IJV responsive to actuation of the massager 106 by the actuator 108. The neck massaging system 104 may include additional optional elements, such as at least one of a size adjustment system 110, a sensor system 112, a positioning system 114, electrical circuitry 116, memory 118, a battery 120, or an input/output 122.

The housing 102 is configured to support one or more components of the neck massaging system 100. The housing 102 may include at least one exterior surface configured to have one or more components disposed therein or attached thereto. The housing 102 may also include at least one interior surface defining an interior region. In other words, the housing 102 may be hollow. The hollow housing 102 allows one or more components of the neck massaging system 100 to be at least partially disposed in the interior region thereby. The housing 102 may at least partially protect any components disposed in the interior region from, for instance, dust, water, or fall damage caused by dropping the neck massaging system 100. The housing 102 may define one or more openings therein that allow the components disposed in the interior region to partially extend out of the interior region or otherwise effect the neck. For instance, the housing 102 may define an opening that allows the massager 106 to partially extend out of the interior region to massage the neck while the remainder of the massaging system 104 may remain protected in the interior region. The housing 102 may also include openings configured to allow the sensor system 112 to detect one or more characteristics outside of the housing 102 and/or openings that allow the positioning system 114 to illuminate a selected region of the neck, as will be discussed in more detail below.

The housing 102 may be formed from any suitable material. In an example, the housing 102 may be formed from a moldable polymer. In such an example, the housing 102 may be formed from two or more pieces (e.g., a top piece and a bottom piece defining the interior region) that are directly attached together. In an example, the housing 102 may be 3D printed. In an example, at least a portion of the exterior surface of the housing 102 may include a cushioning material. The cushioning material may better distribute the pressure applied from the housing 102 to the neck thereby making the housing 102 more comfortable to wear.

The housing 102 may exhibit any suitable shape. In an embodiment, the housing 102 may exhibit a generally U-shape when positioned around the neck. In such an embodiment, the housing 102 may exhibit an open end. In an example, the open end may be sufficiently large to allow the neck to slide through the open end and into the interior region defined by the housing 102. In an example, the open end may not be sufficient to have the neck slid therethrough. In such an example, the opposing portions of the housing 102 may be pulled apart so that the open end becomes large enough to receive the neck. In an embodiment, the housing 102 may exhibit a generally O-shape when positioned around the neck. In such an embodiment, the head may be received into the interior region and the housing 102 is slide down the head to the neck.

In an embodiment, the housing 102 may be formed from a single piece. In an embodiment, the housing 102 may be formed from a plurality of pieces that are rigidly attached together. Forming the housing 102 from a plurality of pieces that are rigidly attached together may simplify manufacturing, and make it easier to dispose components of the neck massaging system 100 in the interior region of the housing 102 than if the housing 102 was formed from a single piece. In an embodiment, the housing 102 may be formed from a plurality of distinct sections that may move relative to each other. In such an embodiment, the distinct sections may be move relative to each other such that the housing 102 conforms to the size and shape of the neck of the individual. For example, the distinct sections may be moved apart from each other when the housing 102 is disposed around a large neck or moved closer together to each other when the housing 102 is disposed around a small neck. Also, the distinct section may be moved such that the massager 106 applies a selected pressure to the neck. For example, the distinct sections may be moved closer together when the massager 106 needs to apply a larger pressure to the neck or moved further apart when the massager 106 needs to apply a smaller pressure to the neck. The pressure that the sections of the housing 102 and the massager 106 presses into the neck may be selected to apply sufficient pressure to the IJV. For example, the massager 106 presses sufficiently hard into the neck to cause the IJV to deform (e.g., at least partially collapse) when the massager 106 moves along the IJV. Deforming the IJV and moving the location of the deformation of the IJV downwards (e.g., towards the heart) causes the massager 106 to pull blood from the cranium and push the blood towards the heart. However, pressing the massager 106 too hard into the neck may at least one of injure the IJV or cause the portions of the housing 102 to continuously compress the IJV, either of which may inhibit blood flow through the IJV. Further, pressing the housing 102 and the massager 106 too hard into the neck may cause the massager 106 to partially compress an artery (e.g., external carotid artery) which may prevent or inhibit blood flow into the brain. Thus, the pressure that the housing 102 and the massager 106 apply to the neck may be impact blood flow through the IJV, and the front clasp 128 may be used to at least partially control the pressure applied from the housing 102 and the massager 106 to the neck. In an embodiment, the housing 102 may be sufficiently stiff so as to substantially prevent articulation of the neck (e.g., for acute care following a car crash). In an embodiment, the housing 102 may be sufficiently flexible so as to permit neck articulation (e.g., thereby allowing long-term use patients to safely perform more daily activities).

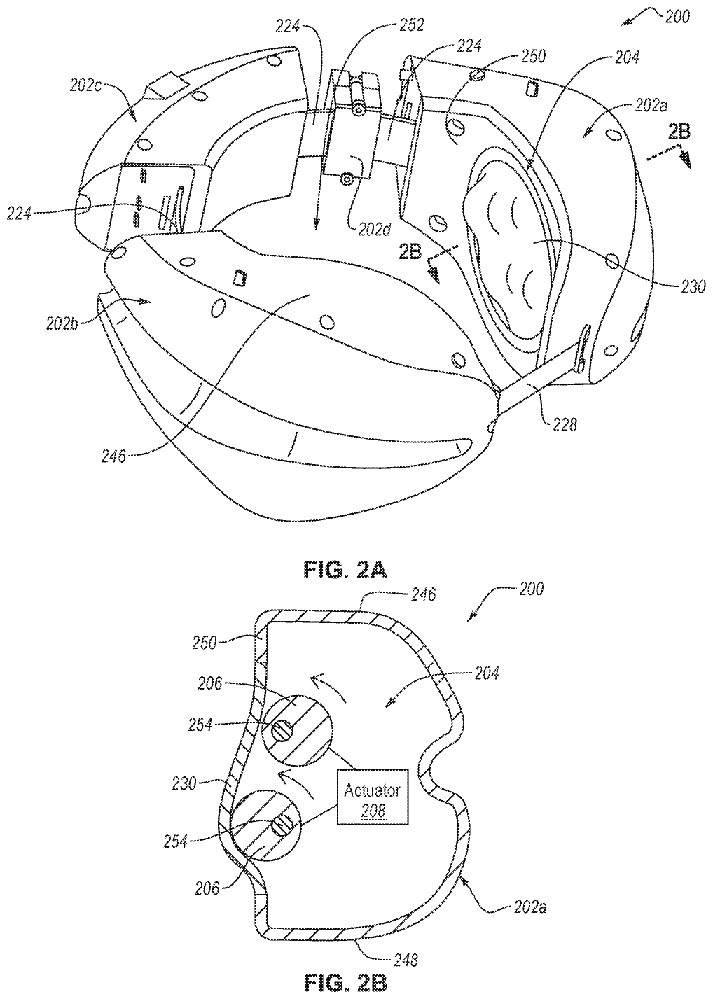

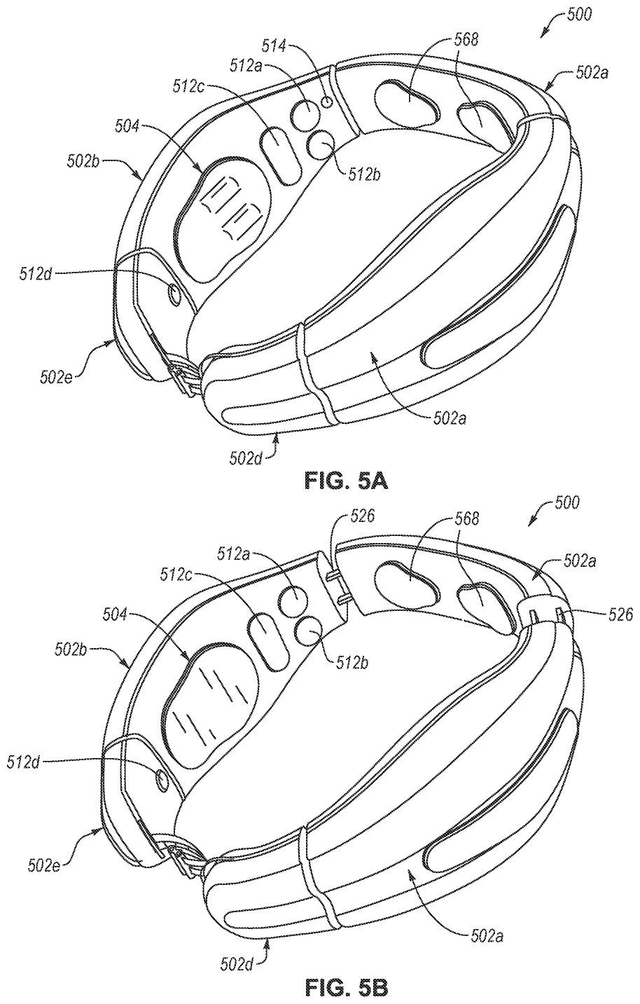

When the housing 102 is formed from a plurality of distinct sections, the neck massaging system 100 may include one or more size adjustment systems 110. The size adjustment systems 110 are configured to moveably attach the distinct sections of the housing 102 together. Examples of the size adjustment system 110 may include one or more of at least one strap, at least one telescoping element, at least one hook-and-loop fastener (e.g., Velcro™), at least one lace used similar to shoe laces, at least one prong-in-a-hole device, any other device that may be used to adjust the distances between the distinct regions of the housing 102, or a combination of any of the foregoing size adjustment systems. Examples of the size adjusting system 100 are discussed in more detail with regards to FIGS. 2A, 5A, and 5B.

The neck massaging system 100 may include one or more wires (not shown) extending through, between, or proximate to the size adjustment system 110. The wires are configured to connect the distinct sections of the housing 102 together. In an example, the wires may allow electrical power to travel between the distinct sections. In an example, the wires may allow the distinct sections to be communicably coupled together.

In an embodiment, the housing 102 may include one or more handling elements configured to facilitate gripping and handling of the neck massaging system 100. In an example, the handling elements may include a groove, channel, or textured surface formed in the exterior of the housing 102 which may decrease the likelihood that the housing 102 is inadvertently dropped. In an example, the handling elements may include a handle, knob, strap, or other feature that may be easily gripped.

The housing 102 may be configured to be positioned around the neck. In an embodiment, the housing 102 is configured to be positioned around a lower portion of the neck, such as resting on the shoulder above the clavicle. Positioning the housing 102 around a lower portion of the neck allows at least some of the massager 106 to be positioned adjacent to or near (e.g., within about 5 cm or less, about 2.5 cm or less, or 1 cm or less) an intersection between the top of the shoulders and the neck. In most individuals, the IJV and the external carotid artery are adjacent to each other at the top of the neck. However, the IJV and the external carotid artery separate from each other with increasing distance from the top of the neck. As such, positioning the housing 102 around a lower portion of the neck increases the likelihood that the massager 106 can contact the IJV without also contacting the external carotid artery. It is noted that it may be desirable to prevent or at least inhibit the massager 106 from contacting the external carotid artery since moving the massager 106 as disclosed herein (e.g., in a direction extending generally from the top of the neck to the bottom of the neck) may impede blood flow through the external carotid artery which, in turn, may decrease blood flow to the brain.

As previously discussed, the neck massaging system 100 incudes a massaging system 104 and the massaging system 104 includes at least one massager 106. The massager 106 is configured to facilitate blood flow through the UV thereby, for example, decreasing intracranial pressure. The massager 106 facilitates blood flow through the IJV by moving the portion of the massager 106 closest to the neck in a general direction extending from a top region of the housing 102 towards the bottom region of the housing 102. Stated another way, the massager 106 facilitates blood flow through the IJV by moving the portion of the massager 106 closest to the neck in a general direction extending from a top of the neck to a bottom of the neck. As previously discussed, such movement by the massager 106 compresses and deforms the IJV, and moves the region of deformation of the IJV downwards to thereby pull blood from the brain and moving the blood towards the heart. In an embodiment, the movement of the massager 106 may be a rotating movement. In such an embodiment, the movement of the massager 106 in a general direction extending from the top region of the housing 102 to the bottom region of the housing 102 (i.e., a general direction extending from the top of the neck to the bottom of the neck) refers to rotation of the massager 106 in a direction that moves blood from the top of the neck (e.g., from the brain) to the bottom of the neck (e.g., towards to heart). Such rotational movement may include (relative to the perspective of an individual standing in from of and facing the wearer of the neck massaging system 100) the left massager(s) 106 moving in a clockwise direction and/or the right massager(s) 106 moving in a counter-clockwise direction. It is noted that the left massager(s) 106 are on the right side of the wearer and the right massager(s) 106 are on the left side of the wearer.

In an embodiment, the massager 106 is configured to apply a force of about 0.25 Newtons (“N”) or greater to the neck, such as about 0.3 N or greater, about 0.4 N or greater, about 0.5 N or greater, about 0.6 N or greater, about 0.7 N or greater, about 0.8 N or greater, about 0.9 N or greater, about 1 N or greater, about 1.25 N or greater, about 1.5 N or greater, about 2 N or greater, about 2.5 N or greater, about 3 N or greater, about 3.5 N or greater, about 4 N or greater, about 5 N or greater, about 6 N or greater, about 7 N or greater, about 8 N or greater, about 9 N or greater, about 10 N or greater, about 12.5 N or greater, about 15 N or greater, or in ranges of about 0.25 N to about 0.4 N. about 0.3 N to about 0.5 N. about 0.4 N to about 0.6 N. about 0.5 N to about 0.7 N. about 0.6 N to about 0.8 N. about 0.7 N to about 0.9 N. about 0.8 N to about 1 N. about 0.9 N to about 1.25 N, about 1 N to about 1.5 N, about 1.25 N to about 2 N, about 1.5 N to about 2.5 N, about 2 N to about 3 N, about 2.5 N to about 3.5 N, about 3 N to about 4 N, about 3.5 N to about 5 N, about 4 N to about 6 N, about 5 N to about 7 N, about 6 N to about 8 N, about 7 N to about 9 N, about 8 N to about 10 N, about 9 N to about 12.5 N, or about 10 N to about 15 N to the neck. In an embodiment, the massager 106 is configured to apply a pressure of about 75 Pascals (“Pa”) or greater, about 100 Pa or greater, about 150 Pa or greater, about 200 Pa or greater, about 300 Pa or greater, about 400 Pa or greater, about 500 Pa or greater, about 750 Pa or greater, about 1 kiloPascals (“kPa”) or greater, about 1.25 or greater, about 1.5 kPa or greater, about 2 kPa or greater, about 2.5 kPa or greater, about 3 kPa or greater, or in ranges of about 75 Pa to about 150 Pa, about 100 Pa to about 200 Pa, about 150 Pa to about 300 Pa, about 200 Pa to about 400 Pa, about 300 Pa to about 500 Pa, about 400 Pa to about 750 Pa, about 500 Pa to about 1 kPa, about 750 kPa to about 1.25 kPa, about 1 kPa to about 1.5 kPa, about 1 kPa to about 2 kPa, about 1.5 kPa to about 2.5 kPa, or about 2 kPa to about 3 kPa. The force and/or pressure applied to the neck by the massager 106 may be selected based on a number of factors. In an example, the force and/or pressure applied to the neck by the massager 106 may be selected based on the thickness of the skin of the neck of the wearer and the depth of the IJV in the neck because the force and/or pressure may need to be increased as the thickness of the skin and depth of the IJV increases. It is noted that the thickness of the skin and depth of the IJV may vary from individual to individual. In an example, the force and/or pressure applied to the neck by the massager 106 may be selected depending on the location of arteries near the portion of the IJV to be massaged (e.g., the force and/or pressure may be decreased when an artery is proximate to the IJV to inhibit the massager 106 affecting blood flow through the artery). Again, the location of any arteries relative to the UV may vary from individual to individual. In an example, the force and/or pressure applied from the massager 106 to the neck may be increased if it is determined that the massager 106 is not having the desired therapeutic effect. In an embodiment, the massager 106 is configured to apply the force and/or pressure in a graded and controlled manner, for example, over a full range of 0.25 N to 15 N or 0.75 Pa to 3 kPa.

As previously discussed, the massaging system 104 includes one or more actuators 108 that are configured to move the massager 106. When the massaging system 104 includes a plurality of massagers 106, the massaging system 104 may include a single actuator for two or more massagers 106 or an actuator for each massager 106. The actuators 108 may operate responsive to direction from the electrical circuitry 116 or responsive to other input (e.g., the wearer activating an on/off switch).

The actuators 108 may be configured to move the massager 106 at a selected frequency (e.g., the frequency at which the massager 106 deforms the IJV). It has been found that the frequency of the massager 106 may affect an ability of the neck massaging system 100 to increase blood flow through the IJV. In an embodiment, the actuators 108 are configured to move the massager 106 such that the massager 106 starts deforming the IJV every 0.1 second to about 0.3 second, about 0.2 second to about 0.4 second, about 0.3 second to about 0.5 second, about 0.4 second to about 0.6 second, about 0.5 second to about 0.7 second, about 0.6 second to about 0.8 second, about 0.7 second to about 0.9 second, about 0.8 second to about 1 second, about 0.9 second to about 1.1 second, about 1 second to about 1.2 second, about 1.1 second to about 1.3 second, about 1.2 second to about 1.4 second, about 1.3 second to about 1.5 second, about 1.4 second to about 1.6 second, about 1.5 second to about 1.8 second, about 1.7 second to about 2 seconds, about 1.8 second to about 2.3 second, about 2 seconds to about 2.5 seconds, about 2.25 seconds to about 2.75 seconds, about 2.5 seconds to about 3 seconds, about 2.75 second to about 3.5 second, about 3 seconds to about 4 seconds, about 3.5 seconds to about 4.5 seconds, about 4 seconds to about 5 seconds, about 4.5 second to about 6 seconds, or greater than 6 seconds. It is noted that the speed at which the rollers rotates depends, in part, on the frequency of the rollers and the diameter of the rollers. In an embodiment, the actuators 108 are configured to move the massager 106 at a frequency in a graded and controlled manner, for example, over a full range of 0.1 second to 6 seconds.

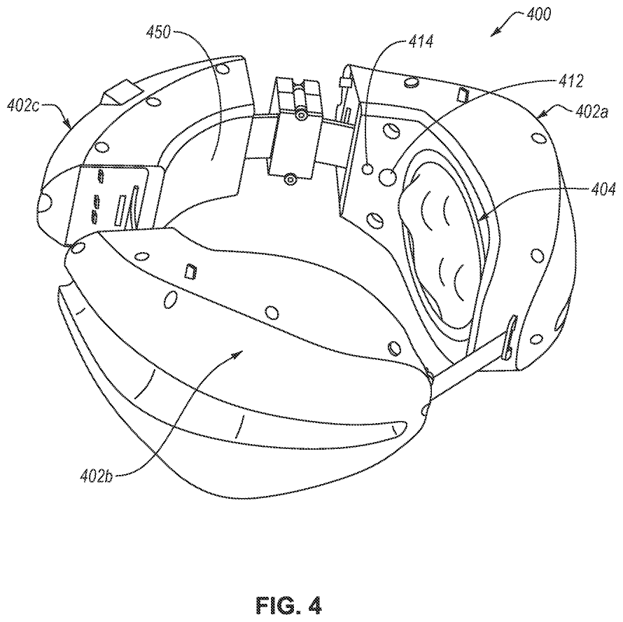

As previously discussed, in some embodiments, the neck massaging system 100 includes a sensor system 112. It should be noted that in other embodiments, the sensor system 112 may be omitted. The sensor system 112 includes one or more sensors that are configured to detect one or more characteristics of the wearer or one or more characteristics of the neck massaging system 100. For example, the sensors of the sensor system 112 may include one or more of at least one vein/artery sensor configured to detect the location of a vein and/or artery, at least one pressure sensor configured to measure the pressure (e.g., force) applied from the housing 102 and/or massager 106 to the neck, at least one blood oxygen sensor, or at least one other sensor. When the sensor system 112 includes a vein/artery sensor, the neck massaging system 100 may include a positioning system 114. The positioning system 114 is configured to facilitate correct positioning of the housing 102 on the neck of the wearer. For example, the positioning system 114 is communicably connected to the vein/artery sensor thereby allowing the vein/artery sensor to communicate the location of a vein (e.g., the UV) or an artery to the positioning system 114. The positioning system 114 may indicate the location of the vein, the location of the artery, or otherwise facilitate placement of the massaging system 104. The sensor system 112 and the positioning system 114 are discussed in more detail with regards to FIG. 4.

In an embodiment, the neck massaging system 100 includes electrical circuitry 116. The electrical circuitry 116 may include at least one processor, a printed circuit board, any other electrical circuitry, or combinations thereof. The electrical circuitry 116 is configured to control the operation of one or more components of the neck massaging system 100. For example, the electrical circuitry 116 may control when the massager 106 moves, the speed or frequency at which the massager 106 moves, the pressure applied from the massager 106 to the neck, etc. In an embodiment, the electrical circuitry 116 may be communicably coupled to the sensor system 112 and may control the components of the neck massaging system 100 responsive to receiving one or more characteristics received from the sensing system 112. In an example, the electrical circuitry 116 may permit or prevent movement of the massager 106 when the vein/artery sensor detects that the massager 106 contacts a vein or artery, respectively. In an example, the electrical circuitry 116 may increase or decrease the pressure applied from the massager 106 to the neck responsive to one or more characteristics sensed by the pressure sensor 136 or the blood oxygen sensor 138.

The neck massaging system 100 may also include memory 118, such as non-transitory memory. The memory 118 may store one or more operational instructions 144 and data thereon. The memory 118 may be communicably coupled to the electrical circuitry 116 and the electrical circuitry 116 may control the components of the neck massaging system 100 responsive to executing the operational instructions 144. The operational instructions 144 may include instructions dictating how the massager 106 is to operate. Examples of such instruction includes instruction dictating at least one of the frequencies at which the massager 106 moves, the pressure applied from the massager 106 to the neck, or how the frequency or pressure is to be varied. The operational instructions 144 may also include instructions on how the sensing system 112 and/or the positioning system 144 are to function. The operational instructions 144 may also dictate how long the neck massaging system 100 may be used, massaging programs, etc.

The neck massaging system 100 includes a power source (e.g., electrical power source) configured to provide energy to the components of the neck massaging system 100. For example, the power source may be configured to provide electrical power to the actuators 108 of the massaging system 104, the sensor system 112, the positioning system 114, the electrical circuitry 116, the memory 118, the moveable support 132, or any other component of the neck massaging system 100. In an embodiment, the power source is a battery 120, such as a 3 volt (“V”) or greater battery, a 6 V or greater battery, or a 9 V or greater battery. The battery may be rechargeable (e.g., lithium ion) or single use battery. Generally, increasing the voltage of the battery 120 allows the neck massaging system 100 to operate more components and/or include stronger actuators but may also result in increasing the weight of the neck massaging system 100. In an embodiment, the neck massaging system 100 is configured to be attached to a power source via a cable or wire that is external to the neck massaging system 100 (e.g., an electrical outlet). In such an embodiment, the neck massaging system 100 may operate longer than and exhibit a weight that is less than a substantially similar neck massaging system 100 that includes the battery 120 and/or for diagnostics when attached to a computer. However, the neck massaging system 100 that is configured to be attached to an external power source may only be operated in an area where the cable or wire may reach. In an embodiment, the neck massaging system 100 may be attached to an external battery (e.g., external battery disposed in a shirt pocket) via a cable or wire.

In an embodiment, the neck massaging system 100 may include at least one input/output 122. The input/output 122 may include at least one of a touchscreen, one or more buttons, a display, a wired or wireless transceiver (e.g., configured to communicate with a computer or cellphone that is external to the neck massaging system 100), a keyboard, or any other suitable input and/or output device. The input/output 122 may allow the wearer or another individual to communicate with the neck massaging system 100. In an example, the input/output 122 may allow the wearer or another individual to input or select a desired program. The program may include a run time, the speed or frequency at which the massager 106 moves, how the speed or frequency of the massager 106 varies, the pressure applied from the massager 106 to the neck, etc. In an example, the input/output 122 may provide information to the wearer or the other individual. Examples of information that the input/output 122 may provide includes the battery's 120 charge, the time period during which the neck massaging system 100 has been actively massaging the neck, the characteristics sensed by the sensor system 112, which program has been selected, the speed or frequency at which the massager 106 moves, one or more error codes, or any other suitable information.

FIGS. 2A-6B illustrate various geometries of neck massaging systems, housings, and massagers. The neck massaging systems, housings, and massagers illustrated in FIGS. 2A to 6B are merely some embodiments of the possible geometries thereof and the neck massaging systems, housings, and massagers disclosed herein may have other geometries other than what is illustrated in FIGS. 2A to 6B.

FIG. 2A is an isometric view of neck massaging system 200, according to an embodiment. Except as otherwise disclosed herein, the neck massaging system 200 may be the same as or substantially similar to any of the neck massaging systems disclosed herein. For example, the neck massaging system 200 includes a housing (collectively formed by the sections 202a, 202b, 202c, and 202d) and a massaging system 204.

The housing includes a top region 246 and a bottom region 248 opposite the top region 246. The top and bottom regions 246, 248 may be spaced from each other in a direction that is generally parallel to gravity when the neck massaging system 200 is being worn and the wearer is seated upright or standing. The housing further includes an interior region 250 defining an opening 252 (e.g., a central opening). In an embodiment, the top region 246, the bottom region 248, and the interior region 250 refer to a top, bottom, and interior surfaces of the housing, respectively. In an embodiment, one or more of the top region 246, the bottom region 248, or the interior region 250 may include at least a portion of a plurality of surfaces or a portion of a single surface.

The housing includes a plurality of distinct sections. For example, the housing 202 includes a first massaging section 202a, a second massaging section 202b, and a battery section 202c. Relative to the wearer, the first massaging section 202a may be configured to massage a left side of the neck and the second massaging section 202b may be configured to massage a right side of the neck. The battery housing 202c may be configured to hold the battery (e.g., battery 120 of FIG. 1). Forming the housing from the plurality of sections allows the shape of the housing to be easily conform to the shape of the neck. For example, forming the housing form the plurality of sections allows each of the sections to be positioned on the neck of the wearer and conform to the shape of the neck regardless of the size and shape of the neck. Forming the housing from the plurality of sections also allows each section to be isolated from each other. For example, forming the housing from the plurality of sections prevents the first and second massaging sections 202a, 202b from being damaged if the battery leaks or otherwise short circuits. Further, forming the housing from the plurality of sections prevents heat generated in the first and second massaging sections 202a, 202b (e.g., friction heat generated by moving the massagers 206 relative to the neck and resistive heat generated by using the actuators 208) from degrading or otherwise decreasing the life span of the battery.

In an embodiment, the housing may include one or more sections other than the first massaging section 202a, the second massaging section 202b, and the battery section 202c. For example, as illustrated, the housing may include a junction box 202d. The junction box 202d may facilitate operation of the strap 224 and may hold electrical components (e.g., electrical circuitry, fuses, etc.) of the neck massaging system 200. In an embodiment, one or more of the first massaging section 202a, the second massaging section 202b, the battery section 202c, or the junction box 202d may be omitted from the housing. For example, the battery section 202c may be omitted and the battery may be stored in one or both of the first massaging section 202a or the second massaging section 202b.

Each of the sections of the housing may be attached together using a size adjustment system. In the illustrated embodiment, each of the sections of the housing may be attached together using straps 224. The straps 224 may include a rigid or elastic web. The straps 224 may extend between and be attached to adjacent ones of the distinct regions of the housing thereby attaching the distinct regions together. For example, the straps 224 may extending between the battery section 202c and each of the first massaging section 202a and the second massaging section 202b. The straps 224 allow the size and shape of the housing to be selectively varied depending on the size and shape of the neck of the wearer. The straps 224 may include one or more wires embedded therein thereby electrically and communicably connecting the sections of the housing together. The straps 224 may be attached to one or more of the distinct regions of the housing using a buckle (e.g., a ladder lock slide buckle). For instance, the buckle may be attached to and/or disposed in any one of the sections of the housing and the straps 224 may be positioned through the buckle. In such an instance, the distance between the sections of the housing may be increased or decreased responsive to sliding the straps 224 through the buckle.

The housing (e.g., the sections of the housing and the straps 224 collectively) exhibits a general U-shape exhibiting an open end. When the housing exhibits the generally U-shape, the size adjustment system 210 may include a front clasp 228. The front clasp 228 is configured to reversibly attached together opposing portions of the housing that form the open end of the U-shaped housing. For example, the front claps 228 configured to be reversibly attached to at least one of the first massaging section 202a or the second massaging section 202b since the first and second massaging sections 202a, 202b define the open end. As such, the front clasp 228 may connect the first and second massaging sections 202a, 202b indirectly together and close the open end when the front clasp 228 is attached to the first and second massaging sections 202a, 202b. Examples of the front clasp 228 include a hook-and-loop fastener, a lace used similar to shoe laces, or a prong-in-a-hole device. The front clasp 228 may permit or restrict movement of the neck through the open end. For example, the front clasp 228 may permit the neck to move through the open end when the front clasp 228 does not attach the first and second massaging sections 202a, 202b together and may restrict the neck from moving through the open end when the front clasp 228 attaches the first and second massaging sections 202a, 202b. In other words, the front clasp 228 may prevent the housing from sliding off the neck during operation. Further, the front clasp 228 also allows the first and second massaging sections 202a, 202b to move apart from each other and/or the open end of the housing to be open when the front clasp 228 is not attached to the first and second massaging sections 202a, 202b which may facilitate positioning the housing around the neck.

In an embodiment, the length of the front clasp 228 is adjustable. Changing the length of the front clasp 228 may be used to affect the pressure applied from the housing and the massager 206 to the neck. In an example, the length of the front clasp 228 may be decreased, thereby pulling the first and second massaging sections 202a, 202b of the housing together which, in turn, pushes the sections of the housing and the massager 206 into the neck. In an example, the length of the front clasp 228 may be increased thereby allowing the first and second massaging sections 202a, 202b of the housing to move apart from each other which, in turn, decreases the pressures applied from the sections of the housing and the massager 206 to the neck.

FIG. 2B is a schematic cross-sectional view of the first massaging section 202a to show the components of the massaging system 204, according to an embodiment. As shown, the massaging system 204 includes at least one massager 206 and at least one actuator 208 configured to move the massager 206. In particular, the actuator 208 is configured to move the massager 206 such that the portion of the massager 206 closest to the neck moves in a general direction extending from the top region 246 to the bottom region 248.

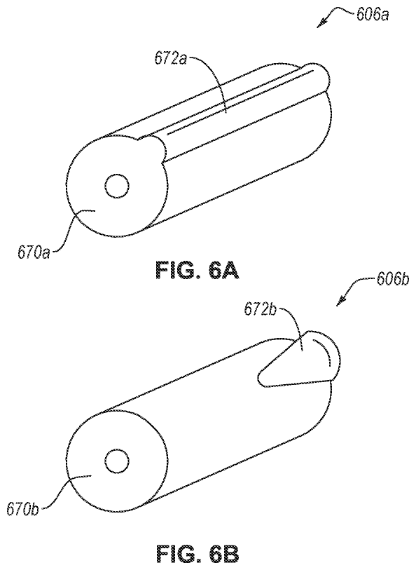

The massager 206 may include any suitable device that is able to move in a general direction extending from the top region 246 of the housing to the bottom region 248 of the housing. In an embodiment, the massagers 206 include rollers (e.g., a generally cylindrical roller). In such an embodiment, each of the rollers may be attached to a shaft 254. The shaft 254 is operable coupled to the actuator 208 such that the actuator 208 may rotate the shaft 254. Rotating the shaft 254 causes the rollers to rotate. In an example, as illustrated, the shaft 254 is not located in the center of the rollers. As such, rotating the shaft 254 causes the rollers to move closer to and further away from the surface of the neck. The rollers may contact and press into the neck (e.g., thereby deforming the IJV) when the shaft 254 rotates the rollers closer to the neck. It is noted that the shaft 254 does not need to be located off-center, as discussed in more detail with regards to FIGS. 6A and 6B. In an embodiment, the massager 206 may include a non-cylindrical roller, such as an ellipsoidal roller, a generally tear-drop shaped roller, a generally triangular roller, etc. When the first massaging section 202a is configured to massage the left side of the neck and the massager 206 includes a roller, the actuator 208 is configured to rotate the massager 206 in a counter-clockwise relative to an individual facing and standing in front of the wearer.

The massaging system 204 may include any suitable number of massagers 206. In an embodiment, when the massager 206 includes rollers, the massaging system 204 may include two or three massagers 206 configured to massage one side of the neck. For example, if the massaging system 204 is configured to massage both sides of the neck simultaneously, the massaging system 204 may include four to six massagers 206. The massaging system 204 including two or three massagers 206 for one side of the neck improves blood flow through the IJV significantly more than if the massaging system 200 only included a single roller. Also, a massaging system 204 that includes four or more massagers 206 for one side of the neck may massage a significantly large area of the neck that prevents the massagers 206 from contacting the external carotid artery or another artery may be difficult. For example, as illustrated, the massaging system 204 includes two massagers 206. The massaging system 204 only includes two massagers 206 due to the size of the housing (e.g., the first and second massaging sections 202a, 202b). As such, including more massagers 206 may require increasing the size of the housing to accommodate more massagers 206. As shown, the size of the housing may not need to be significantly enlarged to accommodate three massagers 206. However, the housing may need to be significantly enlarged to include four or more massagers 206. Significantly enlarging the housing to accommodate four or more rollers may make the housing uncomfortably heavy and may make positioning the massaging system 204 to avoid arteries difficult or impossible.

It is noted that the massagers 206 may include devices other than or in addition to the rollers illustrated in FIG. 2B. For example, the massager 206 may include an inflatable bladder. In such an embodiment, the massaging system 204 may inflate the bladder and then move the inflated bladder downward (e.g., in a general direction extending from the top region 246 of the housing to the bottom region 248 of the housing).

In an embodiment, the actuator 208 may include a motor (e.g., electric motor, air motor, etc.) that is configured to rotate the massager 206 when the massager 206 is a roller. In such an embodiment, the motor may, for example, directly rotate the rollers, directly rotate the shaft 254 attached to the rollers, and/or rotate gears that are directly or indirectly attached to the roller. In an embodiment, the actuators 208 may include a pneumatic or hydraulic pump when the massager 206 includes an inflatable bladder.

In an embodiment, the neck massaging system 200 may include at least one membrane 230. However, in other embodiments, the membrane 230 may be omitted. The membrane 230 may be positioned between the massager 206 and the neck of the individual. For example, the membrane 230 may extend across an opening in the housing (e.g., an opening formed in the first and second massaging sections 202a, 202b) through which the massager 206 extends. The membrane 230 may include a fabric (e.g., synthetic nylon), polyester, polyurethane, polyisoprene, polyether ether ketone, or other deformable material that may be comfortable when worn on a skin surface. In a particular example, the membrane 230 includes polyether ether ketone since polyether ether ketone exhibits high creep resistance, good stress cracking resistance, resistance against high energy radiation, good chemical resistance, is serializable, and exhibits good sliding and wear properties. The membrane 230 may prevent the massager 206 from pulling on the skin and hair of the neck as the massager 206 moves.

In an embodiment, the membrane 230 is reversibly attachable to the housing. In such an embodiment, the membrane 230 may be removed and disposed of after using the neck massaging system 200 and a new membrane 230 may be attached to the housing before using the neck massaging system 200 again. In other words, a new sterile membrane may be installed over the massagers 206 between two sessions of user by the same or different individuals.

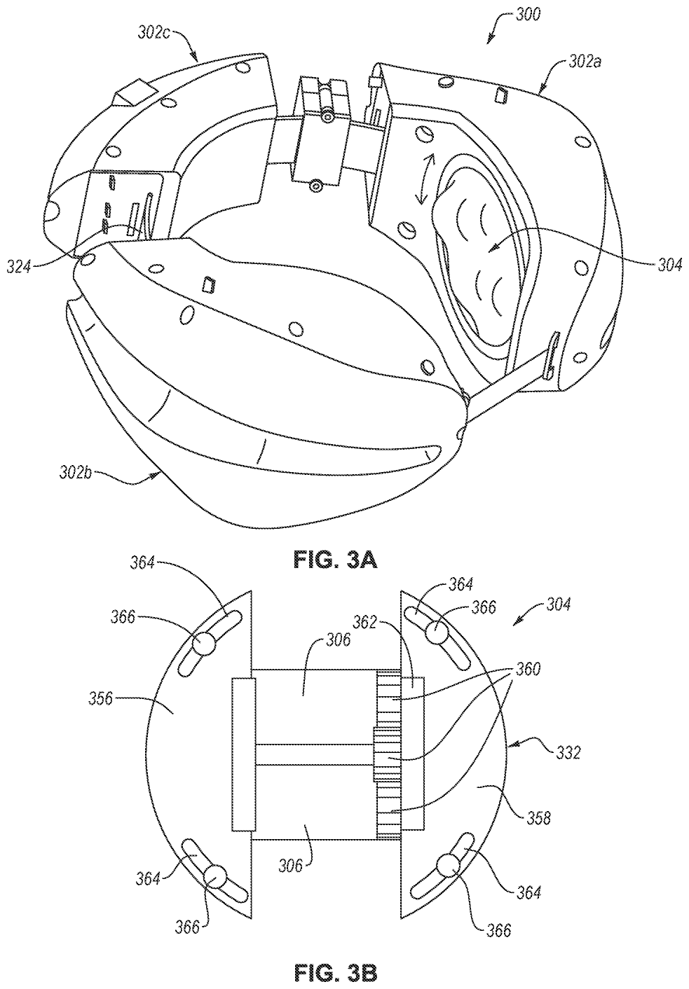

FIG. 3A is an isometric view of a neck massaging system 300, according to an embodiment. Except as otherwise disclosed herein, the neck massaging system 300 is the same as or substantially similar to any of the neck massaging systems disclosed herein. For example, the neck massaging system 300 may be substantially similar to the neck massaging system 200. As such, the neck massaging system 300 may include a housing (collectively formed from one or more of a first massaging section 302a, a second massaging section 302b, a battery section 302c, etc.) and a massaging system 304.

At least a portion of the massaging system 304 is configured to move (e.g., rotate) relative to the neck. As such, the massaging system 304 may include a moveable support 332. FIG. 3B is a top plan view of the moveable support 332, according to an embodiment. The moveable support 332 is configured to support and hold the massager 306. The moveable support 332 may support other components of the massaging system 304, such as the actuators 308. In an example, the moveable support 332 is able to move relative to the housing (e.g., relative to one of the first massaging section 202a or the second massaging section 202b) which, in turn, moves the massager 306 relative to the housing. In an example, the moveable support 332 is configured to rotate the massager 306 relative to the housing which, in turn, allows the massager 306 to rotate the massager 306 relative to the neck. The ability to rotate the massager 306 relative to the neck allows the massager 306 to move generally parallel to the IJV. When the massager 306 is a roller, the massager 306 rotates generally parallel to the IJV when the axis of rotation of the roller is generally perpendicular to the IJV. It is currently believed that the massager 306 is more effective when the massager 306 moves generally parallel to the IV. As such, the moveable support 332 may improve the effectiveness of the massager 306.

In a particular embodiment, as illustrated, the moveable support 332 includes a first plate 356 and a second plate 358. The first and second plates 356, 358 are configured to support and hold the massagers 306. For example, the first and second plates 356, 358 may allow the massagers 306 to rotate relative to the first and second plates 356, 358. The first and second plates 356, 358 may be configured to support and/or hold one or more other components of the massaging system 304. For example, the first and second plates 356, 358 may support and/or hold one or more gears 360 that are configured to transfer rotational energy from the actuator (not shown) to the massagers 306. In an embodiment, the first and second plates 356, 358 may include an attachment region 362. The attachment region 362 is configured to having the massagers 306 and, optionally, the gears 360 or other components of the massaging system 304 attached thereto. The attachment region 362 may be a thickened region of the first and second plates 356, 358.

In an embodiment, the first and second plates 356, 358 each define one or more elongated perforations 364 extending therethrough. Each of the elongated perforations 364 may exhibit a curved shape, such as a curved shape corresponding to a segment of a circle. The moveable support 332 may include a plurality of fasteners 366. Each of the fasteners 336 may extend through one of the elongated perforations 364 and be attached to the housing. As such, the fasteners 366 attach the first and second plates 356, 358 (and the components attached to the first and second plates 356, 358) to the housing. The fasteners 336 may be sufficiently loose to allow the first and second plates 356, 358 to rotate relative to the housing. In particular, the curved shape of the elongated perforations 364 allows the first and second plates 356, 358 to rotate relative to the housing.

In an example, the moveable support 332 is configured to move the massager 306 into or away from the neck (e.g., out of and into the housing, respectively) instead of or in addition to rotating the massager 306. The moveable support 332 that moves the massager 306 toward or away from the surface of the neck also allows the moveable support 332 to control the pressure that the massager 306 applies to the neck. In an example, the moveable support 332 may move the massager 306 toward the neck (e.g., out of the housing) to increase the pressure applied from the massager 306 to the neck or away from the neck (e.g., into the housing) to decrease the pressure applied from the massager 306 to the neck. In an embodiment, the moveable support 332 includes one or more shims and movement of the shims cause the massager 306 to move into or away from the neck. In an embodiment, the moveable support 332 is configured to move the massager 306 away from the neck when the pressure applied from the massager 306 to the neck exceeds a threshold value. The shims may form part of a force feedback system that controls the pressure applied from the massager 306 to the neck.

In an embodiment, the moveable support 332 is configured to move the massager 306 response to direct handling by the wearer or another individual. For example, the moveable support 332 may be configured to rotate the massager 306 and/or move the massager 306 into or out of the housing responsive to the wearer or another individual physically rotating, pulling on, pushing on, or otherwise moving the moveable support 332. In an embodiment, the moveable support 332 may be operably coupled to one or more actuators (not shown) that move the moveable support 332.

FIG. 4 is an isometric view of a neck massaging system 400, according to an embodiment. Except as otherwise disclosed herein, the neck massaging system 400 is the same as or substantially similar to any of the neck massaging systems disclosed herein. For example, the neck massaging system 400 may be substantially similar to the neck massaging system 200. As such, the neck massaging system 400 may include a housing (collectively formed from one or more of a first massaging section 402a, a second massaging section 402b, a battery section 402c, etc.) and a massaging system 404.

The neck massaging system 400 includes a sensor system 412. The sensor system 412 includes one or more sensors that are configured to detect one or more characteristics of the wearer or one or more characteristics of the neck massaging system 400. In an embodiment, the sensor system 412 includes a vein/artery sensor. The vein/artery sensor is configured to detect the location of a vein and/or artery (e.g., the IJV, the common carotid artery, internal carotid artery, the external carotid artery, or another artery). Examples of the vein/artery sensor include an ultrasound sensor (e.g., a cervical duplex ultrasound probe, a Doppler ultrasound probe), a tomography probe (e.g., an optical coherence tomography probe), another sensor that may detect a vein or artery, or combinations of the foregoing. The vein/artery sensor may be used to correctly position the housing around the neck of the wearer such that the massager contacts the IJV and/or prevent the massager from contacting an artery. To facilitate detection of the vein and/or artery, the vein/artery sensor may be located on or near the interior region 450 of the housing.

When the sensor system 412 includes the vein/artery sensor, the neck massaging system 400 may include a positioning system 414. The positioning system 414 is configured to facilitate correct positioning of the housing on the neck of the wearer. In an embodiment, the positioning system 414 is communicably connected to the vein/artery sensor, thereby allowing the vein/artery sensor to communicate the location of a vein (e.g., the IJV) or an artery to the positioning system 414. The positioning system 414 may include a light emitting device (e.g., a laser, a light emitting diode, etc.) and an actuator. Responsive to receiving the location of the vein or artery from the vein/artery sensor, the light emitting device may emit a light and the actuator may move the light emitting device 440 such that the light emitting device illuminates the vein or the artery. In other words, the positioning system 414 may indicate a location on the neck that may or may not have the massaging system 404 positioned adjacent thereto. Thus, the wearer or another individual handling the housing may position the housing on the neck such that the massager contacts the vein and/or avoids the artery. The light emitting device may be positioned adjacent to or at least on the same section of the housing as the massaging system 404 and the sensor system 412 to prevent the neck from obstructing the light emitted by the positioning system 414. It is noted that the positioning system 414 may include elements other than or in addition to the light emitting device and the actuator. In an example, the positioning system 414 may include a vibratory or other haptic feedback device which provides haptic feedback (e.g., vibrates) when the massager is disposed over a vein and/or an artery. In an example, the positioning system 414 may include a display and the display may provide words (e.g., move left/right) or images (e.g., an image of the neck showing the vein and/or artery with an indication of the location of the massager relative to the vein and/or artery) which may be used to position the housing.

The sensor system 412 may include sensors other than or in addition to the vein/artery sensor. In an embodiment, the sensor system 412 may include a pressure sensor 436 configured to measure the pressure (e.g., force) applied from the housing and/or massager to the neck. Examples of the pressure sensor 436 include a piezoelectric sensor, a piezocapacitive pressure sensor, a force gauge, a strain gauge, any other suitable sensor, or combinations thereof. In an embodiment, the sensor system 412 may include a blood oxygen sensor 438. The blood oxygen sensor 438 may be used to detect adverse health events in the wearer (e.g., low blood oxygen levels caused by COVID-19) or may detect when the massager is inadvertently deforming an artery. In an embodiment, the sensor system 412 may include a pulse sensor configured to detect the pulse of the individual which may indicate when the massager is advantageously or adversely affecting blood flow. The sensor system 412 may also include other sensors, such as a temperature sensor (e.g., configured to detect a body temperature of the wearer or a temperature of the neck massaging system 400), an image sensor (e.g., active-pixel sensor), acoustic sensor, chemical sensor, electrical current/voltage sensor (e.g., multimeter), moisture sensor, position sensor, velocity sensor (e.g., measuring the speed at which the massager moves), proximity sensor, or any other sensor.

The neck massaging systems disclosed herein may exhibit shapes and/or configurations other than what is illustrated in FIGS. 2A-4. For example, FIGS. 5A and 5B are isometric views of a neck massaging system 500, according to an embodiment. Except as otherwise disclosed herein, the neck massaging system 500 may be the same as or substantially similar to any of the neck massaging systems disclosed herein. For example, the neck massaging system 500 may include a housing, a massaging system 504, a sensor system (e.g., an optical coherence tomography probe 512a, a cervical duplex ultrasound 512b, a Doppler ultrasound 512c, a pulse sensor 512d, and/or any other suitable sensor), a positioning system 514, and a size adjustment system. It is noted that any of the neck massaging systems disclosed herein may include the features of the neck massaging system 500.

The housing of the neck massaging system 500 may include a plurality of distinct sections. For example, the housing may include a first massaging section 502a, a second massaging section 502b, and a battery section 502c. The housing may also include one or more additional sections, such as a chip housing section 502d configured to house the electric circuitry and memory of the neck massaging system 500 and an input/output section 502e that includes the input/output of the neck massaging system 500. These additional sections of the housing may isolate more components of the neck massaging system from each other in case of damage. The additional sections of the neck massaging system may also facilitate sizing and conforming the housing to the size and shape of the neck. It is noted that the housing may include sections other than the sections illustrated in FIGS. 5A and 5B. Also, it is noted that one or more of the sections illustrated in FIGS. 5A and 5B may be omitted.

As previously discussed, the neck massaging system 500 includes a size adjustment system. In an embodiment, as illustrated, the size adjustment system 510 includes a telescoping mechanism 526 (shown in FIG. 5B). The telescoping element 526 may extend between adjacent regions of the housing. The distinct regions of the housing may be configured to slide along the telescoping element 126 thereby increasing or decreasing the distance between the distinct elements which, in turn, allows the size and/or shape of the housing to be controllably changed. For example, FIG. 5A illustrates the neck massaging system 500 when the size of the housing is in a first state. The housing is in the first state when the size (e.g., circumference) of the housing is minimized (e.g., the telescoping mechanism 526 is fully retracted). FIG. 5B illustrates the neck massaging system 500 when the size of the housing exhibits a second state. The housing exhibits the second state when the size of the housing is increased relative to the first state. For example, as illustrated, the housing is in the second state when at least some of the telescoping mechanisms 526 are at least partially protracted. In an embodiment, the telescoping element 526 may include a telescoping hinge.

In an embodiment, the neck massaging system 500 includes a secondary massaging system 568. The secondary massaging system 568 is distinct from the massaging system 504. In an example, the secondary massaging system 568 is configured to massage one or more veins other than the UV to improve blood flow through such veins. In an example, the secondary massaging system 568 is configured to massage an artery. In such an example, the massagers of the secondary massaging system 568 may move in a generally direction extending from a base of the neck to the top of the neck. In an example, the secondary massaging system 568 is not configured to massage one or more veins or arteries. In such an example, the secondary massaging system 568 may configured to massage one or more muscles or is configured to otherwise relieve stress. As such, the secondary massaging system 568 may increase the therapeutic effectiveness of the massaging system 504 may relaxing neck muscles that may impede the massaging system 504 from massaging the IJV and/or reduce stress-caused blood pressure.

The rollers illustrated in FIG. 2B exhibit a generally cylindrical shape and include a rotational axis thereof is located off-center. However, as previously discussed, other rollers may be used in the massaging systems disclosed herein. FIGS. 6A and 6B are isometric views of different massagers, according to different embodiments. It is noted that the massagers of FIGS. 6A and 6B may be used in any of the massaging systems disclosed herein.

Referring to FIG. 6A, the massager 606a exhibits a generally cylindrical body 670a and at least one protrusion 672a extending from the body 670a. The protrusion 672a may extend along all or substantially all of the length of the cylindrical body 670a. The protrusion 672a also extends outwardly from the cylindrical body 670a by uniform distance. The protrusion 672a is configured to deform the IJV and move along the IJV as the massager 606a rotates thereby promoting blood flow through the IJV. Due to the presence of the protrusion 672a, the axis of rotation of the cylindrical body 670 may be located at or near the center thereof though, it is noted, this is not required.

Referring to FIG. 6B, the massager 606b is the same as any of the massagers disclosed herein except as otherwise disclosed herein. For example, the massager 606b exhibits a generally cylindrical body 670b and at least one protrusion 672b extending from the body 670b. The protrusion 672b does not extend a uniform distance from the body 670b. Instead, the distance the protrusion 672b extends from the body 670b varies.

In an embodiment, the massager 606b may be used when the UV is proximate to an artery. In such an embodiment, the apex of the protrusion 672b (i.e., the portion of the protrusion 672b that extends furthest from the body 670b) may be positioned to contact the IJV. The other portions of the protrusion 672b are less likely to deform or otherwise affect the artery compared to the apex of the protrusion 672b since the other portions of the protrusion 672b do not extend as far from the body 670.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. A neck massaging system, comprising:
a housing defining an opening configured to receive a neck, the housing including a top region, a bottom region opposing the top region, an interior region defining at least a portion of the opening;
at least one massager attached to the housing adjacent to the interior region, the at least one massager positioned on the housing to be positioned proximate to the internal jugular vein when the opening receives the neck; and
at least one actuator operably coupled to the at least one massager, the at least one actuator configured to move the at least one massager such that a portion of the at least one massager proximate to the neck moves in a general direction extending from the top region towards the bottom region.

2. The neck massaging system of claim 1, wherein the housing includes a first section and second section distinct from the first section, a distance between the first section and the second section is configured to be selectively varied.

3. The neck massaging system of claim 1, wherein the housing includes an open end; and
further comprising a front clasp attached to the housing, the front clasp configured to selectively close or open the open end.

4. The neck massaging system of claim 1, wherein the at least one massager includes an inflatable bladder.

5. The neck massaging system of claim 1, wherein the at least one massager includes at least one roller configured to rotate in a general direction extending from the top region towards the bottom region.

6. The neck massaging system of claim 5, wherein the at least one roller exhibits a generally cylindrical shape.

7. The neck massaging system of claim 5, wherein the at least one roller includes a body and at least one protrusion extending from the body.

8. The neck massaging system of claim 5, wherein the at least one roller includes two or three rollers on a left side of the housing and two or three rollers on a right side of the housing.

9. The neck massaging system of claim 1, wherein the at least one actuator is configured to vary at least one of a pressure applied from the at least one massager to the internal jugular vein or a frequency at which the at least one massager moves.

10. The neck massaging system of claim 1, further comprising at least one moveable support, the at least one massager is attached to and supported by the at least one moveable support, the at least one moveable support configured to rotate relative to a remainder of the housing.

11. The neck massaging system of claim 1, further comprising a membrane extending over the at least one massager.

12. The neck massaging system of claim 1, further comprising at least one vein/artery sensor, the at least one vein/artery sensor configured to identify at least one of the internal jugular vein, the common carotid artery, the internal carotid artery, or the external carotid artery, or the external carotid artery.

13. The neck massaging system of claim 12, further comprising a light-emitting device communicably connected to the at least one vein/artery sensor, the light-emitting device configured to illuminate at least one of the internal jugular vein or the external carotid artery responsive to the at least one vein/artery sensor identifying at least one of the internal jugular vein or the external carotid artery.

14. The neck massaging system of claim 12, wherein the at least one vein/artery sensor includes at least one of an ultrasound sensor or an optical coherence tomography probe.

15. The neck massaging system of claim 1, further comprising electrical circuitry and at least one non-transitory memory coupled to the electrical circuitry, the at least one non-transitory memory storing one or more operational instructions and the electrical circuitry configured to execute the operational instructions.

16. The neck massaging system of claim 1, further comprising at least one additional massager spaced from the at least one massager.

17. A method of using a massaging system, the method comprising:
positioning a housing of the neck massaging system around a neck of a wearer such that the neck is disposed in an opening defined by the housing, the housing including a top region, a bottom region opposite the top region, and an interior region defining at least a portion of the opening;
adjusting the housing such that at least one massager of the neck massaging system is positioned adjacent to the internal jugular vein of the individual, the at least one massager is attached to the housing; and
moving a portion of the at least one massager closest to the neck in a general direction extending from the top region towards the bottom region using at least one actuator coupled to the at least one massager.

18. The method of claim 17, wherein adjusting the housing such that at least one massager of the neck massaging system is positioned adjacent to the internal jugular vein of the individual includes adjusting the housing such that the at least one massager is positioned at or near a base of the neck and is spaced from an external carotid artery of the wearer.

19. The method of claim 17, wherein the at least one massager includes at least one roller and moving at least a portion of the at least one massager includes rotating the at least one roller.

20. The method of claim 17, wherein moving at least a portion of the at least one massager includes varying at least one of a pressure applied from the at least one massager to the internal jugular vein or a frequency at which the at least one massager moves.
